(19) United States
(12) Patent Application Publication
(10) Pub. No.: US 2026/0318684 A1
(43) Pub. Date: Oct. 15, 2026

(54) AUTOMATED EXTRACTION METHOD FOR RIVER NETWORK CENTERLINES AND CATCHMENTS WITH PRESERVATION OF RIVER NETWORK DENSITY

(71) Applicant: Institute of Atmospheric Physics,Chinese Academy of Sciences, Beijing (CN)

(72) Inventor: Hui ZHENG, Beijing (CN)

(21) Appl. No.: 19/459,103

(22) Filed: Jan. 26, 2026

(30) Foreign Application Priority Data
Apr. 11, 2025 (CN) 202510454274.6

(51) Int. Cl. G01C 13/00

(52) U.S. Cl. CPC G01C 13/006

(57) ABSTRACT

An automated extraction method for river network centerlines and catchments with preservation of river network density is provided. The method includes: inputting a two-dimensional river network density distribution as a spatial variable, and combining flow direction data to realize the collaborative extraction of river network centerlines and catchments while maintaining consistency between the density of the extracted river network in each local watershed unit and the input density field.

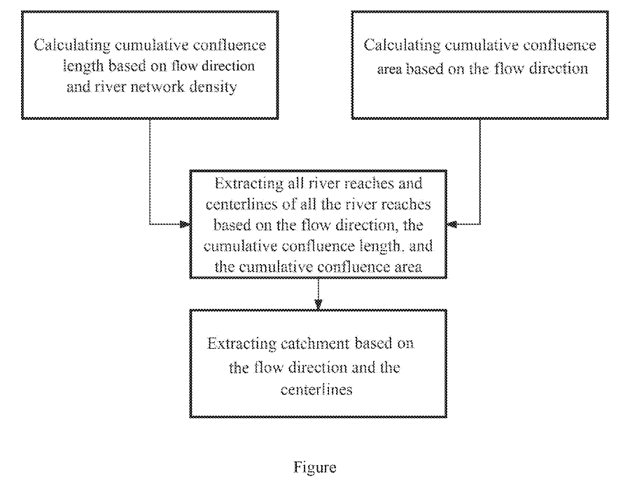

### CROSS-REFERENCE TO RELATED APPLICATIONS

This application claims priority to Chinese Patent Application No. 202510454274.6, filed on Apr. 11, 2025, the contents of which are hereby incorporated by reference.

### TECHNICAL FIELD

The present disclosure relates to an automated extraction method for river network centerlines and catchments with preservation of river network density.

### BACKGROUND

River network extraction based on Digital Elevation Models (DEMs) is a key step in hydrological simulation, and its accuracy directly affects the simulation effect of hydrological processes. Current mainstream river network extraction methods typically include: (1) calculating flow direction from DEM data; (2) calculating cumulative confluence area; (3) setting a fixed threshold to extract river channel centerlines; and (4) dividing catchments. Among them, both step (3) and step (4) rely on an artificially set unified cumulative confluence area threshold.

The prior art has the following significant technical defects: the use of a fixed threshold may lead to inconsistency between the extracted river network density (total length of river channels per unit area) and the actual situation. This is because river network density in natural watersheds has significant spatial heterogeneity, affected by multiple factors such as terrain, geology, and climate, while a fixed threshold may not reflect such spatial variation characteristics.

Existing methods adopt a multi-level threshold strategy to solve the problem. However, the multi-level threshold method requires multiple iterative calculations, which significantly increases computational resource consumption. When applied to large watersheds, the computational cost may increase substantially, which may limit practical applicability.

### SUMMARY

To address the above technical problems, the present disclosure provides an automated extraction method for river network centerlines and catchments with preservation of river network density, including:
calculating cumulative confluence length based on flow direction and river network density;
calculating cumulative confluence area based on the flow direction;
extracting all river reaches and centerlines of all the river reaches based on the flow direction, the cumulative confluence length, and the cumulative confluence area;
and extracting catchments based on the flow direction and the centerlines.

Optionally, a process of calculating the cumulative confluence length based on the flow direction and the river network density includes:
initializing a count of inflow grids for each grid to zero;
traversing flow direction grids and incrementing count of inflow grids of downstream grids by one;
initializing cumulative confluence length of each grid by multiplying grid area of each grid with by the river network density;
traversing all grids to find grids with zero inflow grids, and serving the grids with zero inflow grids as river sources;
and sequentially selecting one of grids of the river sources as a current grid, searching downstream according to the flow direction, and calculating the cumulative confluence length.

Optionally, a process of searching the downstream according to the flow direction and calculating the cumulative confluence length includes:
finding a downstream grid of the current grid according to the flow direction;
when the current grid has no downstream grid, terminating the search;
when the downstream grid exists, updating cumulative confluence length of the downstream grid to be sum of the cumulative confluence lengths of the downstream grid and the current grid;
and when the count of the inflow grids of the downstream grid is greater than or equal to two, decrementing the count of the inflow grids of the downstream grid by one and terminating the search;
otherwise, setting the downstream grid as the current grid and re-finding the downstream grid of the current grid according to the flow direction.

Optionally, a process of calculating the cumulative confluence area based on the flow direction includes:
initializing the count of the inflow grids for each grid to zero;
traversing the flow direction grids and incrementing the count of the inflow grids at the downstream grid by one;
initializing the cumulative confluence area of each grid as grid area;
traversing all the grids to find the grids with zero inflow grids, and serving the grids with zero inflow grids as the river sources;
and sequentially selecting one of grids of the river sources as current grid, searching downstream according to the flow direction, and calculating the cumulative confluence area.

Optionally, a process of searching the downstream according to the flow direction and calculating the cumulative confluence area includes:
finding the downstream grid of the current grid according to the flow direction;
and when the current grid has no downstream grid, terminating the search;
when the downstream grid exists, updating the cumulative confluence are of the downstream grid to be the sum of the cumulative confluence areas of the downstream grid and the current grid; and
when the count of the inflow grids of the downstream grid is greater than or equal to two, decrementing the count of the inflow grids of the downstream grid by one and terminating the search;
otherwise, setting a downstream grid as a current grid and re-finding the downstream grid of the current grid according to the flow direction.

Optionally, a process of extracting all the river reaches and the centerlines of all the river reaches based on the flow direction, the cumulative confluence length, and the cumulative confluence area includes:
initializing an empty centerline temporary queue and an empty centerline completion queue, both the empty centerline temporary queue and the empty centerline completion queue storing the centerlines of the river reach, where each centerline of river reach is represented by a grid sequence, and a front-back order of the grids indicates upstream-downstream relationship;
traversing the flow direction grids;
when a grid has no downstream grid or a downstream grid is outside the search area, the grid is an outlet, and each watershed outlet grid in the centerline temporary queue as a centerline grid sequence of length one;
selecting a river reach centerline at a front of the centerline temporary queue, and removing from the centerline temporary queue;
and calculating selected river reach centerline to obtain all river reach data and centerline data.

Optionally, a process of calculating the selected river reach centerline to obtain all the river reach data and the centerline data includes:
calculating a target length of the river reach centerline;
when the river reach centerline has no upstream, such as centerline temporary queue or the empty centerline completion queue flows to the centerline, the target length is equal to the cumulative confluence length at the most downstream grid of the river reach centerline;
otherwise, the target length is equal to the cumulative confluence length at the most downstream grid of the river reach centerline minus the sum of the cumulative confluence lengths at the most downstream grids of all upstream centerlines;
when the length of the centerline is greater than or equal to the target length, storing the centerline in the completion queue and terminating the loop;
when the length of the centerline is less than the target length, searching for an upstream grid set of the centerline according to the flow direction;
comparing the cumulative confluence areas based on the upstream grid set to find a grid with the largest cumulative confluence area as a candidate grid;
when the candidate grid flows to the most upstream grid of the centerline, adding the candidate grid to a front of the river channel centerline sequence, recalculating target length of the river reach centerline;
when the candidate grid does not flow to the most upstream grid of the centerline, finding a downstream grid of the candidate grid according to the flow direction, dividing the centerline into an upstream segment and a downstream segment with the downstream grid of the candidate grid as the boundary, where the upstream segment does not include the downstream grid of the candidate grid, and the downstream segment includes the downstream grid of the candidate grid, and both the upstream centerline and downstream centerline are stored at an end of the centerline temporary queue;
storing the candidate grid in the centerline temporary queue as a centerline grid sequence of length one at an end of the queue;
and reselecting a river reach from a front of the centerline temporary queue, removing from the queue, calculating the target length of the river reach centerline, and making a judgment;
and repeating the judgment process until the centerline temporary queue is empty, where at this time the empty centerline completion queue stores the centerlines of all river reaches in the river network.

Optionally, a process of extracting the catchments based on the flow direction and the centerlines includes:
establishing an empty exclusion set;
when the centerline has upstream centerlines, traversing the upstream centerlines of the centerline, and adding the most downstream grid of each upstream centerline to the empty exclusion set to obtain an exclusion set;
initializing an empty catchment temporary queue and an empty catchment completion set, both the catchment temporary queue and the completion set storing grids covered by the catchment;
pushing the grids in the centerline sequence into an end of the catchment temporary queue in the order from downstream to upstream;
and when the catchment temporary queue is not empty, taking a grid from a front of the catchment temporary queue, storing in the completion set, removing from the catchment temporary queue, finding all grids of upstream taken grid extent not yet included by the completion set or the exclusion set according to the flow direction, and pushing the grids into the end of the catchment temporary queue;
and repeating the process until the catchment temporary queue is empty to complete the extraction of the catchment.

Optionally, the river network centerline is represented by the grid through which the river network centerline passes, and the river network centerline vector is obtained by vectorizing the grid with the river network centerline passes.

Compared with the prior art, the present disclosure has the following advantages and technical effects.

Aiming at the problem of river network density distortion caused by a globally unified threshold in existing river network extraction methods, the present disclosure provides an automated extraction based on dynamic river network density constraints. By inputting a two-dimensional river network density distribution as a spatial variable and combining flow direction data, the collaborative extraction of river network centerlines and catchments is realized, and the density of the extracted river network in each local watershed unit is maintained consistent with the input density field by automatically adjusting the extracted centerlines thereby extending one or more centerline segments until the density deviation value is within the catchments and regulate the water movement in the rivers.

### BRIEF DESCRIPTION OF THE DRAWING

The accompanying drawing forming a part of the present disclosure is used to provide a further understanding of the present application. The schematic embodiment and description of the present application are used to explain the present disclosure and do not constitute an improper limitation of the present application. In the accompanying drawing:

The Figure is a schematic flow chart of the method according to an embodiment of the present disclosure.

### DETAILED DESCRIPTION OFTHE EMBODIMENT

It may be noted that the embodiment in the present disclosure and the feature in the embodiment may be combined with each other without conflict. The present disclosure will be described in detail below with reference to the accompanying drawing and embodiment.

### Embodiment

As shown in the figure, the present embodiment provides an automated extraction method for river network centerlines and catchments with preservation of river network density, including:

1. calculating the cumulative confluence length based on flow direction and river network density.

The cumulative confluence length is defined as the total length of all trunk and tributary rivers upstream of a certain grid (or river network node), i.e., the sum of the lengths of water flow paths flowing to the grid.

The cumulative confluence length may be calculated through the following steps:
(1) calculating the number of inflow grids for each grid:
   1) initializing the number of inflow grids for each grid to zero; and
   2) traversing flow direction grids and incrementing the number of inflow grids of the downstream grid by one.
(2) Calculating the cumulative confluence length:
   1) initializing the cumulative confluence length of each grid as the product of its grid area and river network density;
   2) traversing all grids to find grids with zero inflow grids, which are river sources; and
   3) sequentially selecting one of the river source grids as a current grid and searching downstream according to the flow direction:
      (a) finding the downstream grid of the current grid according to the flow direction; when the current grid has no downstream grid, terminating the search;
      (b) when a downstream grid exists, updating the cumulative confluence length of the downstream grid to be the sum of the cumulative confluence lengths of the downstream grid and the current grid; and
      (c) when the number of inflow grids of the downstream grid is greater than or equal to two, decrementing the number of inflow grids of the downstream grid by one and terminating the search; otherwise, setting the downstream grid as the current grid and repeating steps (a) to (c).

2. Calculating the cumulative confluence area based on the flow direction.

The cumulative confluence area is defined as the total area of all confluence regions upstream of a certain grid (or river network node), i.e., flow to the grid.

The cumulative confluence area may be calculated through the following steps:

(3) calculating the number of inflow grids for each grid: 1) initializing the number of inflow grids for each grid to zero; and

2) traversing flow direction grids and incrementing the number of inflow grids of the downstream grid by one.

(4) Calculating the cumulative confluence area: 1) initializing the cumulative confluence area of each grid as its grid area; 2) traversing all grids to find grids with zero inflow grids, which are river sources; and

3) sequentially selecting one of the river source grids as the current grid and searching downstream according to the flow direction: (a) finding the downstream grid of the current grid according to the flow direction; when the current grid has no downstream grid or the downstream grid is outside the search area, terminating the search; (b) when a downstream grid exists, updating the cumulative confluence area of the downstream grid to be the sum of the cumulative confluence areas of the downstream grid and the current grid; and (c) when the number of inflow grids of the downstream grid is greater than or equal to two, decrementing the number of inflow grids of the downstream grid by one and terminating the search; otherwise, setting the downstream grid as the current grid and repeating steps (a) to (c).

3. Extracting river network centerlines based on the flow direction, the cumulative confluence length, and the cumulative confluence area.

In the embodiment, the river network centerline is represented by the grid where the river network centerline is located, and the river network centerline vector may be obtained by vectorizing the grid where the river network centerline is located.

The river network centerline is extracted by iteratively searching upstream from the watershed outlet grid, with the specific steps as follows:
(1) initializing an empty centerline temporary queue and an empty centerline completion queue, both the empty centerline temporary queue and the empty centerline completion queue, both queues storing the centerlines of the river reach, where each river reach is represented by a grid sequence, and front-back order of the grids indicates upstream-downstream relationship;
(2) traversing the flow direction grids; when a grid has no downstream grid or the downstream grid is outside a search area, the grid is a watershed outlet, and each watershed outlet grid is stored in the empty centerline temporary queue as a centerline grid sequence of length one to obtain a centerline temporary queue;
(3) selecting a river reach centerline at a front of the centerline temporary queue, and removing from the centerline temporary queue; and
(4) for the selected river reach centerline, performing the following steps in a loop:
   a) calculating the target length of the river reach centerline. When the centerline has no upstream, i.e., centerline temporary queue or the empty centerline completion queue flows to the centerline, the target length is equal to the cumulative confluence length at the most downstream grid of the river reach centerline; otherwise, the target length is equal to the cumulative confluence length at the most downstream grid of the river reach centerline minus the sum of the cumulative confluence lengths at the most downstream grids of all its upstream centerlines. When the length of the centerline is greater than or equal to the target length, storing the centerline in the completion queue and terminating the loop; otherwise, executing the following steps;
   b) searching for the upstream grid set of the centerline according to the flow direction. The grids in the set meet three conditions:
      1) adjacent to any grid in the centerline;
      2) flow to the centerline; and
      3) not included in any centerline in the temporary queue or the completion queue. When the upstream grid set is empty, storing the river channel centerline in the completion queue and terminating the loop; otherwise, executing the following steps;
   c) comparing the cumulative confluence areas in the upstream grid set to find the grid with the largest cumulative confluence area as a candidate grid;
   d) when the candidate grid flows to the most upstream grid of the centerline, adding the candidate grid to the front of the river channel centerline sequence, returning to step (a) and repeating the loop; otherwise, executing the following steps;
   e) finding the downstream grid of the candidate grid according to the flow direction, dividing the centerline into an upstream segment and a downstream segment with the downstream grid of the candidate grid as the boundary, where the upstream segment does not include the downstream grid of the candidate grid, and the downstream segment includes the downstream grid of the candidate grid, and storing both the upstream and downstream centerline segments at the end of the centerline temporary queue; and
   f) storing the candidate grid in the centerline temporary queue as a centerline grid sequence of length one at the end of the queue, and terminating the loop.
(5) Repeating step (3) and step (4) until the centerline temporary queue is empty. At this time, the centerline completion queue stores the centerlines of all river reaches in the river network. In some embodiments, an extracted river network density is determined for each local watershed unit based on a total length of extracted centerline segments within the local watershed unit divided by an area of the local watershed unit, and a density deviation value is computed as a difference between the extracted river network density and an input river network density field for the local watershed unit. When the density deviation value for a local watershed unit exceeds a predetermined tolerance, the method automatically adjusts the extraction by modifying one or more centerline segments. The adjusting may include extending a centerline upstream by adding one or more candidate grid cells selected based on cumulative confluence area until the density deviation value satisfies the predetermined tolerance.

4. Extracting catchments based on the flow direction and the centerlines.

In the present embodiment, the catchments are represented by the grids covered by the catchments, and the catchments boundary may be further obtained by vectorizing the catchment grids.

In the present embodiment, each of the catchments corresponds to one river reach centerline. For the centerline of each river reach in the river network, its corresponding catchment may be extracted through the following steps:
(1) establishing an empty exclusion set; when the centerline has upstream centerlines, traversing the upstream centerlines of the centerline, and adding the most downstream grid of each upstream centerline to the empty exclusion set to obtain an exclusion set;
(2) initializing an empty catchment temporary queue and an empty catchment completion set, both the catchment temporary queue and the completion set storing grids covered by the catchment;
(3) pushing the grids in the centerline sequence into an end of the catchment temporary queue in the order from downstream to upstream;
(4) when the catchment temporary queue is not empty, taking a grid from the front of the catchment temporary queue, storing it in the completion set, removing it from the temporary queue, and executing the following steps in a loop;
(5) finding all grids upstream of the taken grid that are not included in the completion set or the exclusion set according to the flow direction, and pushing these grids into the end of the catchment temporary queue;
(6) repeating step (4) and step (5) until the catchment temporary queue is empty. At this point, the completion set stores the catchment corresponding to the river reach centerline, all grids in the catchment completion set flow to the centerline, determining control parameters for a pump or gate based on the extracted catchment; and transmitting a command to regulate water movement in the catchment.

The above are only preferred specific implementations of the present application, but the protection scope of the present application is not limited thereto. Any person skilled in the art may easily think of changes or substitutions within the technical scope disclosed in the present application, and all such changes or substitutions should be covered within the protection scope of the present application. Therefore, the protection scope of the present application should be subject to the protection scope of the claims.

What is claim is:

1. An automated extraction method for river network centerlines and catchments with preservation of river network density, comprising:
calculating cumulative confluence length based on flow direction and river network density;
calculating cumulative confluence area based on the flow direction;
extracting all river reaches and centerlines of all the river reaches based on the flow direction, the cumulative confluence length, and the cumulative confluence area; and
extracting catchments based on the flow direction and the centerlines;
wherein a process of calculating the cumulative confluence length based on the flow direction and the river network density comprises:
initializing a count of inflow grids for each grid to zero;
traversing flow direction grids and incrementing count of inflow grids of downstream by one;
initializing cumulative confluence length of each grid by multiplying grid area of each grid by the river network density;
traversing all grids to find grids with zero inflow grids, and serving the grids with zero inflow grids as river sources; and
sequentially selecting one of grids of the river sources as a current grid, searching downstream according to the flow direction, and calculating the cumulative confluence length;
wherein a process of searching the downstream according to the flow direction and calculating the cumulative confluence length comprises:
finding a downstream grid of the current grid according to the flow direction; and when the current grid has no downstream, terminating search;
when a downstream grid exists, updating cumulative confluence length of the downstream grid to be sum of the cumulative confluence lengths of the downstream grid and the current grid; and
when the count of the inflow grids of the downstream grid is greater than or equal to two, decrementing the count of the inflow grids of the downstream grid by one and terminating the search; otherwise, setting the downstream grid as a current grid and re-finding the downstream grid of the current grid according to the flow direction for judgment.

2. The method according to claim 1, wherein a process of calculating the cumulative confluence area based on the flow direction comprises:
initializing the count of the inflow grids for each grid to zero;
traversing the flow direction grids and incrementing the count of the inflow grids of the downstream grids by one;
initializing cumulative confluence area of each grid as grid area;
traversing all the grids to find the grids with zero inflow grids, and serving the grids with zero inflow grids as the river sources; and
sequentially selecting one of grids of the river sources as current grid, searching downstream according to the flow direction, and calculating the cumulative confluence area.

3. The method according to claim 2, wherein a process of searching the downstream according to the flow direction and calculating the cumulative confluence area comprises:
finding the downstream grid of the current grid according to the flow direction; when the current grid has no downstream, terminating search;
when the downstream grid exists, updating cumulative confluence area of the downstream grid to be sum of the cumulative confluence areas of the downstream grid and the current grid; and
when the count of the inflow grids of the downstream grid is greater than or equal to two, decrementing the count of the inflow grids of the downstream grid by one and terminating the search; otherwise, setting a downstream grid as a current grid and re-finding the downstream grid of the current grid according to the flow direction for judgment.

4. The method according to claim 1, wherein a process of extracting all the river reaches and the centerlines of all the river reaches based on the flow direction, the cumulative confluence length, and the cumulative confluence area comprises:
initializing an empty centerline temporary queue and an empty centerline completion queue, both queues storing the centerlines of the river reach, wherein each centerline of river reach is represented by a grid sequence, and front-back order of the grids indicates upstream-downstream relationship;
traversing the flow direction grids; and when a grid has no downstream grid or downstream is outside a search area, the grid is a watershed outlet, and each watershed outlet grid is stored in the centerline temporary queue as a centerline grid sequence of length one;
selecting a river reach centerline at a front of the centerline temporary queue, and removing from the queue; and
calculating selected river reach centerline to obtain all river reach data and centerline data.

5. The method according to claim 4, wherein a process of calculating the selected river reach centerline to obtain all the river reach data and the centerline data comprises:
calculating target length of the river reach centerline; when the river reach centerline has no upstream, such as no centerline in the temporary queue or the completion queue flows to the centerline, the target length is equal to the cumulative confluence length at the most downstream grid of the river reach centerline; otherwise, the target length is equal to the cumulative confluence length at the most downstream grid of the river reach centerline minus the sum of the cumulative confluence lengths at the most downstream grids of all upstream centerlines; when the length of the centerline is greater than or equal to the target length, storing the centerline in the completion queue and terminating a loop;
when the length of the centerline is less than the target length, searching for an upstream grid set of the centerline according to the flow direction;
comparing the cumulative confluence areas based on the upstream grid set to find the grid with a largest cumulative confluence area as a candidate grid;
when the candidate grid flows to most upstream grid of the centerline, adding the candidate grid to a front of a river channel centerline sequence, recalculating the target length of the river reach centerline, and making a judgment;
when the candidate grid does not flow to the most upstream grid of the centerline, finding downstream grid of the candidate grid according to the flow direction, dividing the centerline into an upstream segment and a downstream segment with the downstream grid of the candidate grid as the boundary, wherein the upstream segment does not comprise the downstream grid of the candidate grid, and the downstream segment comprises the downstream grid of the candidate grid, and both the upstream centerline and downstream centerline are stored at an end of the centerline temporary queue;
storing the candidate grid in the centerline temporary queue as a centerline grid sequence of length one at an end of the queue; and
reselecting a river reach from a front of the temporary queue, removing from the queue, calculating the target length of the river reach centerline, and making a judgment; and repeating the judgment process until the centerline temporary queue is empty, wherein at this time the centerline completion queue stores the centerlines of all river reaches in the river network.

6. The method according to claim 1, wherein a process of extracting the catchments based on the flow direction and the centerlines comprises:
establishing an empty exclusion set; when the centerline has upstream centerlines, traversing the upstream centerlines of the centerline, and adding the most downstream grid of each upstream centerline to the exclusion set;
initializing an empty catchment temporary queue and an empty catchment completion set, both the temporary queue and the completion set storing grids covered by the catchment;
pushing the grids in the centerline sequence into an end of the temporary queue in the order from downstream to upstream; and
when the temporary queue is not empty, taking a grid from a front of the temporary queue, storing in the completion set, removing from the temporary queue, finding all grids of upstream taken grid extent not yet comprised by the completion set or the exclusion set according to the flow direction, and pushing the grids into the end of the temporary queue; and repeating the process until the temporary queue is empty to complete the extraction of the catchment.

7. The method according to claim 1, wherein the river network centerline is represented by the grid with the river network centerline is located, and the river network centerline vector is obtained by vectorizing the grid with the river network centerline is located.
